(19) United States
(12) Patent Application Publication
(10) Pub. No.: US 2021/0166334 A1
(43) Pub. Date: Jun. 3, 2021

(54) Construction Bidding and Company Selection System Based on Intellectual Property Rights

(71) Applicant: (SECOND CONNECT CO.,LTD.), Geumi-si (KR)

(72) Inventor: Seong Won LEE, Gumi-si (KR)

(21) Appl. No.: 16/965,399

(22) PCT Filed: Jan. 9, 2019
(86) PCT No.: PCT/KR2019/000355

§ 371 Date: Jul. 28, 2020

(30) Foreign Application Priority Data
Feb. 21, 2018 (KR) 10-2018-0020363

(51) Int. Cl. G06Q 50/18; G06Q 10/06; G06Q 30/08

(52) U.S. Cl. CPC G06Q 50/184; G06Q 30/08; G06Q 10/06

(57) ABSTRACT

The present invention relates to a system for project bidding and company selection based on intellectual property rights. The system includes: a system manager server 100 transmitting/receiving information through an Internet network 200; and an intellectual property right holder's smartphone or server 400 connected to the system manager server 100 through the Internet network. The system manager server 100 includes: at least one intellectual property right database 110 in which various kinds of intellectual property rights are registered; an ordering-party database 120 storing information regarding a ordering party who has made selection when an intellectual property right associated with project content is selected; a right holder information database 130 storing information regarding right holders of the registered intellectual property rights; and a message transmission terminal 140 transmitting a message when an ordering party selects an intellectual property right stored in the intellectual property database 110.

### TECHNICAL FIELD

The present disclosure relates to a system for project bidding and company selection based on intellectual property rights, and more particularly, to a system for project bidding and company selection based on intellectual property rights which can expect activation of patent rights that are in a crisis of burying while protecting the rights of intellectual property right holders, and can reconsider the transparency of bidding processes and bidders.

### BACKGROUND ART

In general, a bidding refers to a series of procedures that an ordering-party to be provided with project, service, and supply of selecting a provider for the project, service, and supply in consideration of submitted price for providing thereof to a certain point, among a plurality of providers who intend to provide the project, service, and supply.

In recent years, although electronic bidding through information equipment and communication networks is commonly carried out, resulting from development of information and communication technologies, still, bidding is placed by directly visiting the bidding place and submitting bidding documents thereto.

After submitting bidding documents, companies are likely to be selected as a contractor by continuing sales activities such as a promotion for contract and meeting persons concerned of the ordering-party, and it is common to submit patents relating to the project content in the bidding documents as an accompanying document, in a case the company holds the patents.

However, in commonplace, a company actually selected as a contractor is a company that does not hold patents. It may be interpreted as the company had school relations, regionalism, or kinship or had a good sales capacity, and transparency on the contractor selection is never be guaranteed.

As such, the process of contractor selection may be comprehended, but the problem occurs at the moment the project starts to progress. When a contractor who does not hold a patent applies a technology related to a patent content of the company holding the patent, to a project site, civil and criminal lawsuits may occur. Finally, ordering-party and consumers are suffered by resulting project delays and losses.

The problem does not end there, also, patents to be used commercially and economically are buried in commonplace.

### DISCLOSURE

### Technical Problem

Accordingly, an object of the present disclosure is to provide a system for project bidding and company selection based on intellectual property rights, which can protect the right of intellectual property right holder and minimize consumable sales loss and can reconsider the transparency of bidding processes and bidders, in order to solve the above problems.

Another object of the present disclosure is to induce a company that holds an intellectual property right to be selected as a final contractor to exclude civil and criminal disputes that may occur in process of project in advance, and to activate patent rights that are buried due to lack of sales capacity, despite a technology thereof.

### Technical Solution

According to an aspect of the present disclosure, a system (S) for project bidding and company selection based on intellectual property rights includes a system manager server (100) including one or more intellectual property rights databases (110) that various intellectual property rights are registered in and the registered intellectual property right is stored in accordance with a code number given by a field thereof, a ordering-party database (120) that information of a ordering-party is stored when the ordering-party selects a intellectual property right related to project content, a right holder database (130) that information of a right holder of the registered intellectual property right is stored, and a message transmission device (140) that transmits a message of successful bidding to the right holder of the intellectual property right stored in the right holder database (130), when the ordering-party selects the intellectual property right stored in the intellectual property rights database (110), and transmits and receives information to and from Internet network (200) on the basis of a micom, multiple smartphones of unspecified ordering-party or servers (300) connected to the system manager server (100) through the Internet network, and a smartphone of intellectual property right holder or a server (400) connected to the system manager server (100) through the Internet network.

When the intellectual property right is registered in the system manager server, an expert in the related art may judge content of the intellectual property right in technology, maintenance after project, efficiency, and quality then register the intellectual property right.

In the intellectual property right registered in the system manager server (100), newly registered intellectual property right on a weekly, monthly, or quarterly basis may be updated.

### Advantageous Effects

As described above, a system for project bidding and company selection based on intellectual property rights according to an aspect of the present disclosure can protect right of intellectual property right holder and minimize consumable sales loss, and prevent project delays and losses by excluding intellectual property dispute that may occur in process of project in advance since the company is selected based on intellectual property rights.

### DESCRIPTION OF DRAWINGS

FIG. 1 is a block diagram illustrating a preferred embodiment of the present disclosure.

FIG. 2 is a block diagram illustrating a preferred intellectual property rights database according to the embodiment of the present disclosure.

### MODE FOR DISCLOSURE

In order to achieve the above object, a system S for project bidding and company selection based on intellectual property rights of the present disclosure is specifically described as follows, based on the attached drawings.

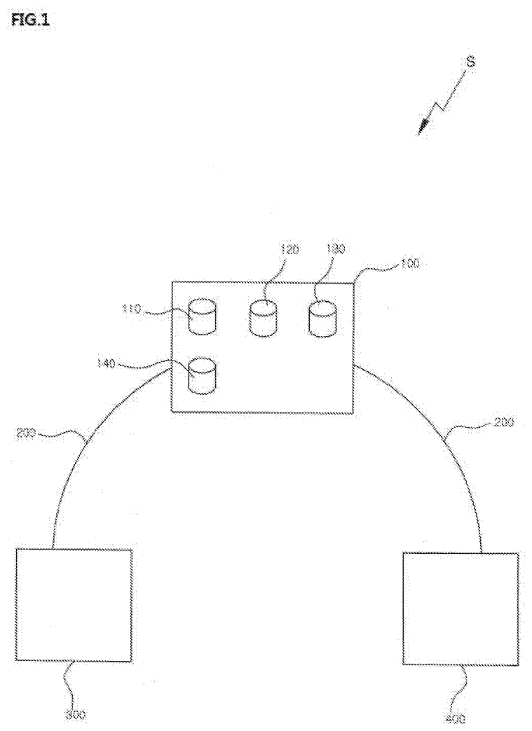

First, the system S for project bidding and company selection based on intellectual property rights of the present disclosure is constituted by, as illustrated in FIG. 1, a system manager server 100 in a social network format, a smartphone of ordering-party or a server 300, and a smartphone of intellectual property right holder or a server 400.

In the system manager server 100, an intellectual property rights database 110, where various intellectual property rights are registered in and the registered intellectual property right is stored in accordance with a code number given by a field thereof, is constructed.

The intellectual property rights refer to industrial property rights of patents, utility models, designs, trademarks, and the like and copyrights of literature, music, artwork, and the like.

In addition, when the intellectual property right is registered in the system manager server, an expert in the related art may judge the content of the intellectual property right in technology, maintenance after project, efficiency, and quality then register the intellectual property right to give ordering-party a trust, and examiners may be organized with plural members such as more than 5 years practitioners in the related art, professional certification holders, and the like.

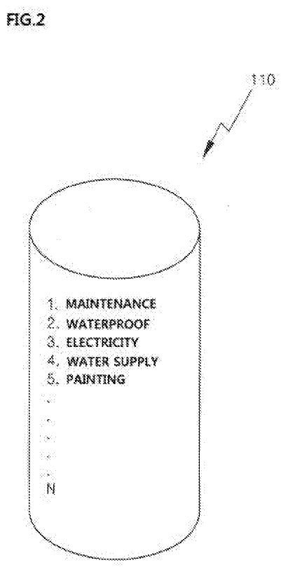

Furthermore, the code number used for storing in the intellectual property rights database 110 may be assigned with a serial number as illustrated in FIG. 2, or an International Patent Classification (IPC) code known in the art may be used.

In addition to the intellectual property rights database 110, the system manager server 100 includes an ordering-party database 120 that information of an ordering-party is stored when the ordering-party selects an intellectual property right related to project content, a right holder database 130 that information of a right holder of the registered intellectual property right is stored, and a message transmission device 140 that transmits a message of successful bidding to the right holder of the intellectual property right stored in the right holder database 130 when the ordering-party selects the intellectual property right stored in the intellectual property rights database 110.

The system manager server 100 is based on a micom, thus when the ordering-party selects any one of the intellectual property rights, the message transmission device 140 is configured to simultaneously transmit a message to a contact of the right holder of the intellectual property right, and transmitting and receiving of information is performed through an Internet network 200.

Furthermore, in the intellectual property right registered in the system manager server 100, newly registered intellectual property right on a weekly, monthly, or quarterly basis may be updated. And registration date is written so that the ordering-party may check whether intellectual property rights are recent intellectual property rights or past intellectual property rights.

A process of placing a bid and selecting a contractor according to a system S for project bidding and company selection based on intellectual property rights is as follows.

First, the ordering-party access to the system manager server 100 through Internet network using a smartphone or a server (PC) provided at the ordering-party, and selects the intellectual property right related to the project details.

When the ordering-party selects the intellectual property right, information (address, phone number, or the like) of the ordering-party is guided to input in the ordering-party database 120, and simultaneously the same is stored in the ordering-party database 120.

As described above, when the ordering-party selects the intellectual property right, the ordering-party information is transferred with a message to a smartphone of holder of the selected intellectual property right through the message transmission device 140, the intellectual property right holder may check brief information of the ordering-party. Thus, it may be a form of a blockchain in which checking of both the ordering-party and the holder is possible.

As described above, the intellectual property right holder becomes the company selected by the ordering-party, and when the ordering-party submits a project site, period, scale, and the like, the intellectual property right holder submits cost and specifications for the project, and then the project may proceed in earnest.

Of course, if the ordering-party cannot accept the cost and specifications for the project submitted from the intellectual property right holder, the ordering-party may withdraw the selection of the company and may search and select another company.

The ordering-party may refer to residents of an apartment, a specific individual, or a public office and a company of municipality.

For example, if an ordering-party wants to paint exterior walls of an apartment, the ordering-party selects a contractor in a way of selecting intellectual property rights related to the painting of exterior wall. Therefore, a bidding company (intellectual property right holder) does not need to do a particular business activity, thus can minimize sales losses and prevent burying of hardly acquired patents.

And the ordering-party selects a company directly without bidding (including electronic bidding) from various companies, thus can shorten a period of the project and be assured at least from the intellectual property dispute. In particular, an intellectual property right is registered after the examination of experts, the ordering-party can select a company having more reliability.

If an intellectual property right holder wants to register the intellectual property right in the system manager server 100 for the first time, the holder pays a certain amount of fee, and the paid expenses may be paid to the experts as a cost for examination before the registration.

Meanwhile, when an intellectual property right is selected, a record of the ordering-party that selected the intellectual property right is stored so as anyone can check a history thereof. Furthermore, a separate database is added for the ordering-party to write a project review so that a second party can refer to the review.

1. A system for project bidding and company selection based on intellectual property rights, the system comprising:
a system manager server (100) including:
one or more intellectual property rights databases (110) that various intellectual property rights are registered in and the registered intellectual property right is stored in accordance with a code number given by a field thereof;
an ordering-party database (120) that information of an ordering-party is stored when the ordering-party selects an intellectual property right related to project content;
a right holder database (130) that information of a right holder of the registered intellectual property right is stored; and
a message transmission device (140) that transmits a message of successful bidding to the right holder of the intellectual property right stored in the right holder database (130), when the ordering-party selects the intellectual property right stored in the intellectual property rights database (110), and
transmits and receives information to and from Internet network (200) on the basis of a micom;
multiple smartphones of unspecified ordering-party or servers (300) connected to the system manager server (100) through the Internet network; and
a smartphone of intellectual property right holder or a server (400) connected to the system manager server (100) through the Internet network.

2. The system of claim 1, wherein when the intellectual property right is registered in the system manager server, an expert in the related art judges content of the intellectual property right in technology, maintenance after project, efficiency, and quality then registers the intellectual property right.

3. The system of claim 1, wherein in the intellectual property right registered in the system manager server (100), newly registered intellectual property right on a weekly, monthly, or quarterly basis is updated.
